(19) United States
(12) Patent Application Publication
(10) Pub. No.: US 2026/0181193 A1
(43) Pub. Date: Jun. 25, 2026

(54) METHOD, AND APPARATUS, FOR RECOGNIZING ACTION OF OBJECT FROM FIRST PLURALITY OF VIDEO STREAMS

(71) Applicant: NEC Corporation, Minato-ku, Tokyo (JP)

(72) Inventors: Jiyan WU, Singapore (SG); Masafumi WATANABE, Singapore (SG)

(73) Assignee: NEC Corporation, Minato-ku, Tokyo (JP)

(21) Appl. No.: 19/124,919

(22) PCT Filed: Nov. 7, 2023
(86) PCT No.: PCT/JP2023/040133

§ 371 Date: Apr. 28, 2025

(30) Foreign Application Priority Data
Nov. 21, 2022 (SG) 10202260150W

(51) Int. Cl. H04N 21/218; H04N 7/15; H04N 21/2187; H04N 21/234; H04N 21/2665; H04N 21/431; H04N 21/44; H04N 21/47; H04N 21/81

(52) U.S. Cl. CPC H04N 21/21805; H04N 7/15; H04N 21/2187; H04N 21/23418; H04N 21/2665; H04N 21/4316; H04N 21/44016; H04N 21/47; H04N 21/812

(57) ABSTRACT

The present disclosure provides a method, an apparatus and a system for recognizing an action of an object from a first plurality of video streams, the method comprising: detecting the object from each of the first plurality of video streams; and assigning one of the first plurality of video streams to one of a second plurality of processing units to recognize the action of the object based on an accuracy in recognizing the action of the object of the one of the second plurality of processing units.

### TECHNICAL FIELD

The present disclosure relates to an object's action recognition method, apparatus and system, and more particularly, relates to a method, an apparatus and a system for recognizing an action of an object from multiple video streams through multiple processing units.

### BACKGROUND ART

There are increasing demands to process multiple video streams, for example, to detect an object and recognize an action of the object. Generally, such multiple video streams need to be assigned to action recognition models to perform action recognition and output the recognition results (e.g., running, riding bicycle, two people fighting, etc.). Generally, in an event that camera/video system is large in scale (e.g., more than 200 camera/video streams) but the number of action recognition models (or the number of processing units running the models) is limited, load balancing is required to ensure the tasks of action recognition is distributed over the limited resources, avoid unevenly overloading some action recognition models (or the processing units running the models) while leaving other action recognition (or the processing units running models) idle, thereby making the processing more efficient.

### SUMMARY OF INVENTION

### Technical Problem

However, as models and platforms used in different video processing units may be different, a user will get different action recognition accuracy results even if the same input video stream is assigned to the video processing units. Considering load balancing across multiple video processing units, the action recognition accuracy results will be inconsistent and strongly dependent on the assignment.

There is thus a need to develop a method, apparatus and system for recognizing an action of an object from multiple video streams through multiple processing units, for example, by taking action recognition accuracy of each processing unit and/or a recognition probability of an action from a video stream into account, to address issues and limitations in load balancing and achieve optimal action recognition accuracy and efficiency.

Furthermore, other desirable features and characteristics will become apparent from the subsequent detailed description and the appended claims, taken in combination with the accompanying drawings and this background of the disclosure.

### Solution to Problem

In a first aspect, the present disclosure provides a method for recognizing an action of an object from a first plurality of video streams, the method comprising: detecting the object from each of the first plurality of video streams; and assigning one of the first plurality of video streams to one of a second plurality of processing units to recognize the action of the object based on an accuracy in recognizing the action of the object of the one of the second plurality of processing units.

In a second aspect, the present disclosure provides an apparatus for recognizing an action of an object from a first plurality of video streams, the apparatus comprising: at least one processor; and at least one memory including computer program code; the at least one memory and the computer program code configured to, with at least one processor, cause the apparatus at least to: recognize the object from each of the first plurality of video streams; and assign one of the first plurality of video streams to one of a second plurality of processing units to recognize the action of the object based on an accuracy in recognizing the action of the object of the one of the second plurality of processing units.

In a third aspect, the present disclosure provides a system for recognizing an action of an object from a first plurality of video streams, comprising the apparatus of according to the second aspect and a third plurality of image capturing apparatuses.

### Advantageous Effects of Invention

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

Embodiments of the disclosure will be better understood and readily apparent to one of ordinary skill in the art from the following written description, by way of example only, and in conjunction with the drawings, in which:

FIG. 1 shows a schematic diagram illustrating an overview of a process for recognizing an action of an object from input video streams;

FIG. 2 shows a schematic diagram illustrating a process for recognizing an action of an object from multiple input video streams using a conventional load balancer;

FIG. 3 illustrates a block diagram of a system for recognizing an action of an object from a plurality of video streams according to various embodiments of the present disclosure;

FIG. 4 shows a flow chart illustrating a method for recognizing an action of an object from a first plurality of video streams according to various embodiments of the present disclosure;

FIG. 5 shows a block diagram illustrating a system 500 for recognizing an action of an object from a first plurality of video streams according to various embodiments of the present disclosure;

FIG. 6 shows a block diagram illustrating various components of an action recognition apparatus of FIG. 5 and a process flow between them according to an embodiment of the present disclosure;

FIG. 7 shows a block diagram illustrating a light-weight estimator and an action recognition probability estimation unit of a probability calculation unit according to an embodiment of the present disclosure;

FIG. 8 shows a block diagram illustrating an assignment unit and its communication with a probability calculation unit and multiple video processing units according to an embodiment of the present disclosure;

FIG. 9 shows a flowchart illustrating a process overview of a video stream input unit, a probability calculation unit and an assignment unit of an action recognition apparatus according to an embodiment of the present disclosure;

FIG. 10 shows a flowchart illustrating a Markov Decision Process used to assign each of first plurality of video streams to one of a second plurality of VPUs according to an embodiment of the present disclosure;

FIG. 11 shows a flowchart 1100 illustrating training process of the light-weight classifier or estimator according to an embodiment of the present disclosure;

FIG. 12 shows a flowchart illustrating a process of calculating and estimating a probability of a target action from a video stream according to an embodiment of the present disclosure; and

FIG. 13 shows a schematic diagram of an exemplary computing device suitable for use to execute the method in FIG. 5 and implement the apparatus in FIG. 6.

### DESCRIPTION OF EMBODIMENTS

### Terms Description

Object—an object may be a person, a pet, a vehicle, a thing, an item, a device, a pillar, a furniture, or any matter that is stationery or in motion. An object can be living or non-living. In the case of a living or biological object such as a person and a pet, the object can be typically detected based on an appearance feature, a body part, a bodily characteristic, a motion of the object or a combination thereof. Examples of an appearance feature of an object (person) includes relative position, size, shape and/or contour of eyes, nose, cheekbones, jaw and chin, and also iris pattern, skin colour, hair colour or a combination thereof. A characteristic includes physical attributes such as height, body size, body shape, body ratio, length of limbs, hair colour, skin colour, apparel, belongings, other similar characteristics or combinations.

A motion includes behavioural characteristic such as body movement, position of limbs, direction of movement, moving speed, walking patterns, the way the object stands, moves or talks, change in physical attribute upon interaction with other objects, other similar characteristics or combinations. In the case of a non-living object, the object can be typically based on moving speed, moving characteristic/patterns and change in physical attribute upon interaction with other objects.

In various embodiments of the present disclosure, an object can be detected by an image capturing apparatus such as a camera by capturing an image of the object and identifying the object based on its appearance feature, body part, bodily characteristic, and/or motion of the object in the image. In various embodiments below, the term “sensor” may be used to refer to an image capturing apparatus.

In various embodiments, an object, upon detection, and the data obtained by the sensor, used for and associated with the identification and detection of the object will be assigned to an object identifier for subsequent identification and tracking of the object. A same object ID will be assigned when the object is subsequently identified based on the same or other appearance feature, body part, bodily characteristic, motion of the object or combination thereof.

Action—an action of an object may refer to a type of activity carried out by an object which can be recognized and classified from an image or video stream based on a sequence of physical features (e.g., appearance feature, body part, bodily characteristics) and/or motional/behaviour features (e.g., motions, movements) of the object identified from a video stream. Examples of an action includes sitting, talking, running, jumping, bicycle riding, fighting, stealing.

In one example, an action of an object is recognized based on the same or similar action(s) of the same or similar object(s) previously recognized and stored in a database. In another example, an action of an object is recognized based on a sequence of physical features (e.g., appearance feature, body part, bodily characteristics) and/or motional/behaviour features of both the object and another object in the video stream, such as fighting and throwing an object.

In various embodiments below, an action of an object to be recognized from video streams may be referred to “target action”.

Video stream—a video stream refers to a continuous transmission or input of video or image files. The videos or images may be generated by a processor in connection with an image capturing device or retrieved from a database. In one example, the processor and the database may be in connection with a server. The transmission or input of video or image files may be through wired or wireless (e.g., via NFC communication, Wi-Fi communication, Bluetooth, etc.) or over a network (e.g., the Internet).

Processing unit—a processing unit refers to a processor configured to process a video or image file to recognize an action of an object using one or more action recognition models/algorithms stored in a memory accessible by the processor. Additionally, the processing unit may be further configured to process the video or image file to detect the object using one or more object detection models/algorithm stored in the memory, prior to action recognition process.

Accuracy—an accuracy in recognizing an action of an object refers to an accuracy of a processing unit in recognizing an action of an object from a sequence of motions of the object using one or more action recognition models/algorithms stored in a memory accessible by the processing unit. In one implementation, additional information and features affecting the performance of the processing unit such as such as processing time, video resolution and video duration may be used to determine and adjust the accuracy of the processing unit or assignment of the video stream to the processing unit to detect and recognize an action of an object in the video stream.

Rank—a rank of a processing unit is determined based on its accuracy in recognizing an action of an object as compared to accuracies of other processing unit in recognizing the action of the object. A higher rank indicates that the processing unit has a higher accuracy in recognizing the action of the object than other processing units with lower ranks. In one embodiment, such ranks will be used for video stream assignment. For example, a video stream may be assigned to a higher ranked processing unit having a higher accuracy in recognizing an action of an object if the video stream has a higher level of importance so that the action can be accurately recognized from the highly important video stream; alternatively or additionally, a video stream with lower probability to detect and recognize the action of the object may also be assigned to a higher ranked processing unit having a higher accuracy in recognizing an action of an object so that it is easier and takes less processing power or time to identify and recognize the action from the video stream. Conversely, a video stream may be assigned to a lower ranked processing unit having a lower accuracy in recognizing an action of an object if the video stream has a lower level of importance so that a higher ranked processing unit can be used to process video streams that are more important. Alternative or additionally, a video stream with high probability to detect and recognize the action of the object may be assigned to a lower ranked processing unit having a higher accuracy in recognizing the action of the object so that it can better identify and recognize the action from the video stream.

Probability—a probability relates to how likely an action of an object will be detected and recognized from a video stream and is determined based on a sequence of physical features and/or motional/behaviour features of the object as well as other object features identified from the video stream, such as, but not limited to, a number of objects, a location of the object, a position of a part of the object, a relative distance between the object and another object, a timestamp at which the object and/or the action of the object is detected, a physical attribute (or a change of physical attribute) relating to the object, a change in a size of the object in the video stream, a duration during which the object and/or the action of the object is detected, a location distribution of different objects in the video stream or a combination thereof.

In one implementation, different sets of physical, motional/behaviour and object features may be relied on to detect different actions of an object, and their probabilities to be detected from a video stream. For example, features such as a number of persons, position of arms, object collision, and frequency of arm extension, frequency of object collision can form a set of features for detecting a fighting action, such that when those features are identified from the video stream, e.g., two persons sparring and bumping into each other in a short period of time, the probability of detecting a fighting action as compared to other actions (e.g., bicycle riding, sitting, stealing) is higher.

Weight parameter—a weight parameter is a weightage in a deep learning model assigned and applied to a physical, motional/behaviour or object feature or a combination of two features identified from a video stream to calculate a probability of detecting one or more actions of an object from the video stream. Such weight parameter correlates to an emphasis or a priority given to the feature (or the features combination) in the calculation of the probability.

In one implementation, the weight parameter assigned and applied to a physical, motional/behaviour or object feature or a combination of two features is updated through training of the deep learning model. During training, multiple video streams with known actions (including physical, motional/behaviour, object features, combinations thereof leading to the recognition of the known actions) are used to check if such known actions can be accurately recognized from such video streams. An indication may be generated if the actions recognized from such video streams do not matches the known actions. Upon receiving such indication, the weight parameters of the physical, motional/behaviour, object features and combinations identified from the video streams (and/or other physical, motional/behaviour, object features and combinations contributing to the recognition of the known actions) may be updated accordingly such that the known actions are accurately recognized from such video streams using the updated weight parameters.

Level of importance—a level of important relates to how important is to correctly recognize an action of an object from a video stream. In general, a video stream with a high level of importance will be assigned to a processing unit with a higher rank (higher accuracy) so that the action of the object is more likely to be recognized accurately.

### EXEMPLARY EMBODIMENTS

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system, Long Term Evolution (LTE) system and 5G mobile network system. The computer program when loaded and executed on such a computer effectively results in an apparatus that implements the steps of the preferred method.

Various embodiments of the present disclosure relate to a method and an apparatus for recognizing an action of an object from a plurality of video streams. It is appreciated by a skilled person that such apparatus and the image capturing device may be implemented as part of a system to provide the same technical effect.

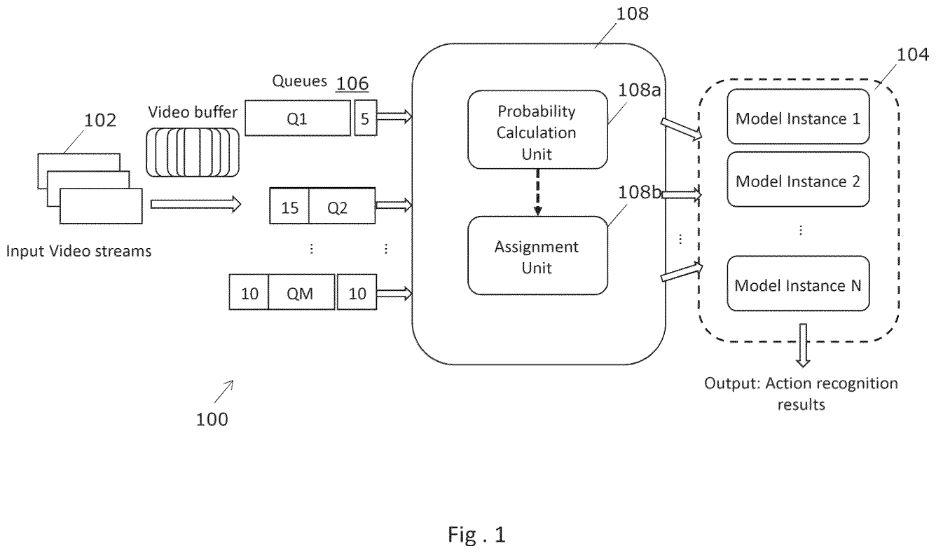

FIG. 1 shows a schematic diagram 100 illustrating an overview of a process for recognizing an action of an object from input video streams 102. Input video streams are put through video buffer and into multiple video streams (indexed from 1 to M in queues 106), and the multiple video streams 106 need to be assigned to one or more processing units to run action recognition models 104 (indexed from 1 to N) for recognition an action(s) of an object(s) (e.g., running, riding bicycle, people fighting) and output the recognition result from the video streams 106. Here, in this example, it is assumed that each action recognition model is run by a processing unit or a processor. However, it is appreciated that a processing unit or a processor may be configured to run more than one action recognition model.

Problem arises in a large-scale camera system, for example, with more than 200 camera streams (and input video streams) when the number of action recognition models (or, especially the number of processing units) is limited, i.e., N<M. In addition, as models and platforms used in processing units may be different, assigning a same video stream to different video processing unit may cause difference in action recognition, thereby affecting the accuracy and reliability of the load balancer.

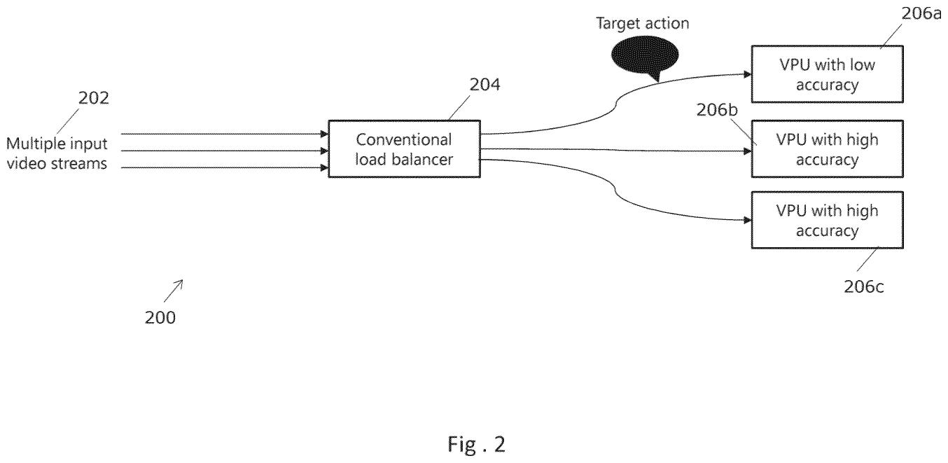

FIG. 2 shows a schematic diagram 200 illustrating a process for recognizing an action of an object from multiple input video streams 202 using a conventional load balancer 204. The conventional load balancer 204 is configured to assign multiple input video streams 202 to three video processing units (VPUs) 206a, 206b, 206c to recognize a target action. Assuming the target action only appears in one of the input video streams, as the conventional load balancer 204 does not take VPU accuracy into account when assigning the video streams 202, the video stream in which the target action appears may be assigned to a VPU with low accuracy (e.g., VPU 206a). As a result, the VPU is unable to detect and recognize the target action and a recognition result showing no target action is detected from the multiple input video streams 202 is output. As such, the user could not get optimal action recognition accuracy if this target action can be detected by other VPUs, for example, VPUs with higher accuracy like VPUs 206b, 206c.

There is thus an object to consider how to assign the multiple video streams load to the limited number of action recognition models. In this present disclosure, new action recognition method, apparatus and system are provided to address such problem and limitations in load balancing between multiple video streams from large-scale camera system and limited action recognition models (processing units) to achieve optimal action recognition accuracy and efficiency.

In one implementation, information such as the action recognition accuracy of a processing unit and the probability of a target action being detected in each a video stream is taken into account in new action recognition method, apparatus and system. For example, as illustrated in FIG. 1, the video streams 106 are fed into the action recognition apparatus 108 comprising a probability calculation unit(s) 108a configured to calculate a probability of recognizing an action of an object from each video stream and an assignment unit 108b configured to assign each video stream to an action recognition model.

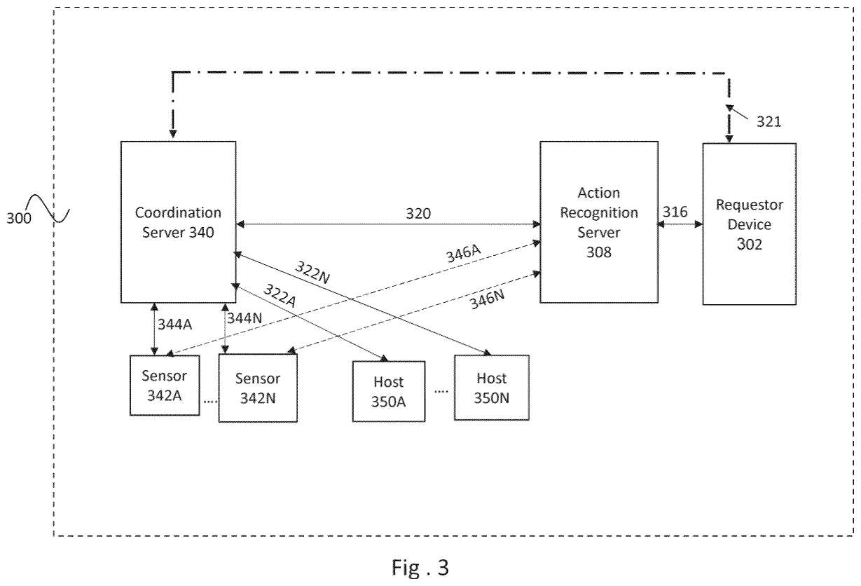

FIG. 3 illustrates a block diagram of a system 300 for recognizing an action of an object from a plurality of video streams according to various embodiments of the present disclosure.

The system 300 comprises a requestor device 302, an action recognition server 308, a coordination server 340, hosts 350A to 350N, and sensors 342A to 342N.

The requestor device 302 is in communication with an action recognition server 308 and/or a coordination server 340 via a connection 316 and 321, respectively. The connection 316 and 321 may be wireless (e.g., via NFC communication, Wi-Fi communication, Bluetooth, etc.) or over a network (e.g., the Internet). The connection 316 and 321 may also be that of a network (e.g., the Internet).

The action recognition server 308 is further in communication with the coordination server 340 via a connection 320. The connection 320 may be over a network (e.g., a local area network, a wide area network, the Internet, etc.). In one arrangement, the action recognition server 308 and the coordination server 340 are combined and the connection 320 may be an interconnected bus.

The coordination server 340, in turn, is in communication with the hosts 350A to 350N via respective connections 322A to 322N. The connections 322A to 322N may be a network (e.g., the Internet).

The hosts 350A to 350N are servers. The term host is used herein to differentiate between the hosts 350A to 350N and the coordination server 340. The hosts 350A to 350N are collectively referred to herein as the hosts 350, while the host 350 refers to one of the hosts 350. The hosts 350 may be combined with the coordination server 340.

In an example, the host 350 may be one that is managed by a security officer of the entity and the coordination server 340 is a central server that coordinates the hosts 350 and decides which of the hosts 350 to forward data or retrieve data like image inputs.

Sensors 342A to 342N are connected to the coordination server 340 or the action recognition server 308 via respective connections 344A to 344N or 346A to 346N. The sensors 342A to 342N are collectively referred to herein as the sensors 342. The connections 344A to 344N are collectively referred to herein as the connections 344, while the connection 344 refers to one of the connections 344. Similarly, the connections 346A to 346N are collectively referred to herein as the connections 346, while the connection 346 refers to one of the connections 346. The connections 344 and 346 may be wireless (e.g., via NFC communication, Wi-Fi communication, Bluetooth, etc.) or over a network (e.g., the Internet). The sensor 342 may be one of an image capturing device, object tracking device, video capturing device, motion sensor and temperature sensor, and may be configured to send an input depending its type, to at least one of the action recognition server 308.

In the illustrative embodiment, each of the devices 302 and 342; and the servers 308, 340, and 350 provides an interface to enable communication with other connected devices 302 and 342 and/or servers 308, 340, and 350. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device comprising a processor or a plurality of interconnected computing devices which operate together to perform a particular function. That is, the server may be contained within a single hardware unit or be distributed among several or many different hardware units.

### <The Coordination Server 340>

The coordination server 340 is associated with an entity (e.g. a company or organization or moderator of the service). In one arrangement, the coordination server 340 is owned and operated by the entity operating the server 308. In such an arrangement, the coordination server 340 may be implemented as a part (e.g., a computer program module, a computing device, etc.) of server 308.

The coordination server 340 may also be configured to manage the registration of users. A registered user has an action recognition account which includes details of the user. The registration step is called on-boarding. A user may use either the requestor device 302 or the host 350 to perform on-boarding to the coordination server 340.

It is not necessary to have an action recognition account at the coordination server 340 to access the functionalities of the coordination server 340. However, there are functions that are available to a registered user. For example, functions such as recognizing more complexed actions or an action involving multiple objects or increased maximum number of video streams input can be exclusive to registered users only.

The on-boarding process for a user is performed by the user through one of the requestor devices 302. In one arrangement, the user downloads an app (which includes the API to interact with the coordination server 340) to the sensor 342. In another arrangement, the user accesses a website (which includes the API to interact with the coordination server 340) on the requestor device 302.

Details of the registration include, for example, user identifier (ID) or appearance portrait of the user, address of the user, contact, or other important information and the sensor 342 that is authorized to update the action recognition account, and the like.

Once on-boarded, the user would have an action recognition account that stores all the details.

### <The Requestor Device 302>

The requestor device 302 is associated with a subject (or requestor) who is a party to an action recognition request that starts at the requestor device 302. The requestor may be a concerned member of the public or a security officer of an entity who is assisting to get data necessary to detect and recognize a target action (e.g., stealing, fighting) of a person(s) or an object within the entity. The requestor device 302 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 302 is a computing device in a watch or similar wearable and is fitted with a wireless communications interface.

### <The Action Recognition Server 308>

The action recognition server 308 is as described above in the terms description section, and is configured to recognize an action of an object from a plurality of video streams.

### <The Hosts 350>

The host 350 is a server associated with an entity (e.g. a company or organization) which manages (e.g. establishes, administers) object information relating to an object which/whose action is recognized.

In one arrangement, the entity is a bank. Therefore, each entity operates a host 350 to manage the resources by that entity. In one arrangement, a host 350 receives an alert signal that a target action is detected. The host 350 may then arrange to send resources to the location identified by the location or camera information included in the alert signal. For example, the host may be one that is configured to obtain relevant video or image input for processing.

In one arrangement, the video stream, the object detected and the action recognized may be stored and updated on the action recognition account associated with the user. Advantageously, such information is valuable to the law enforcement and the user such as security or building management staff who does object identification, tracking and monitoring. It reduces number of hours looking through camera footage to recognize an action of an object.

### <Sensor 342>

The sensor 342 is associated with a user associated with the requestor device 302. The sensor 342 may be one of an image capturing device, object tracking device, video capturing device, motion sensor and temperature sensor, and may be configured to send an input depending its type, to at least one of the action recognition server 308. More details of how the sensors may be utilised for recognizing an action of an object will be provided below.

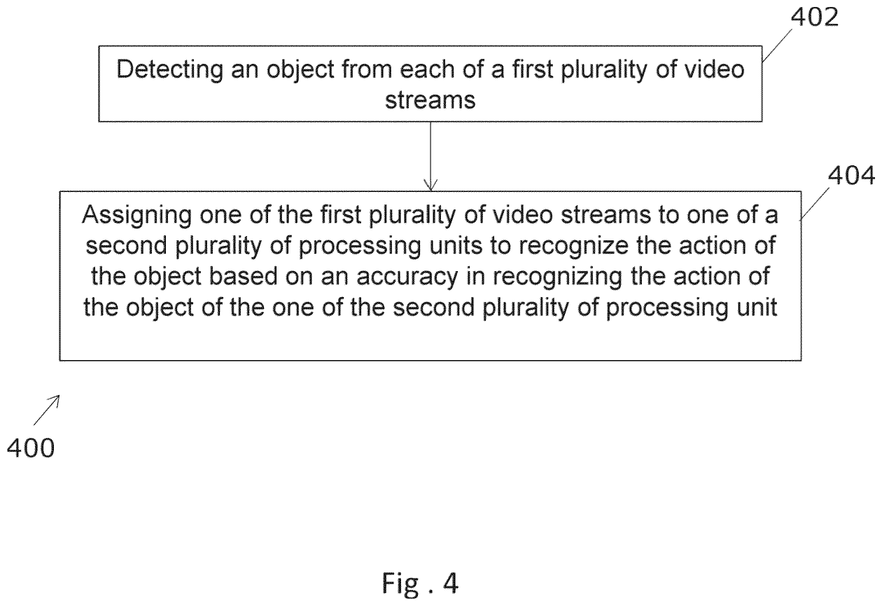

FIG. 4 shows a flow chart 400 illustrating a method for recognizing an action of an object from a first plurality of video streams according to various embodiments of the present disclosure. In step 402, a step of detecting an object from each of the first plurality of video streams is carried out. In step 404, a step of assigning one of the first plurality of video streams to one of a second plurality of processing units to recognize the action of the object based on an accuracy in recognizing the action of the object of the one or more of the second plurality of processing unit.

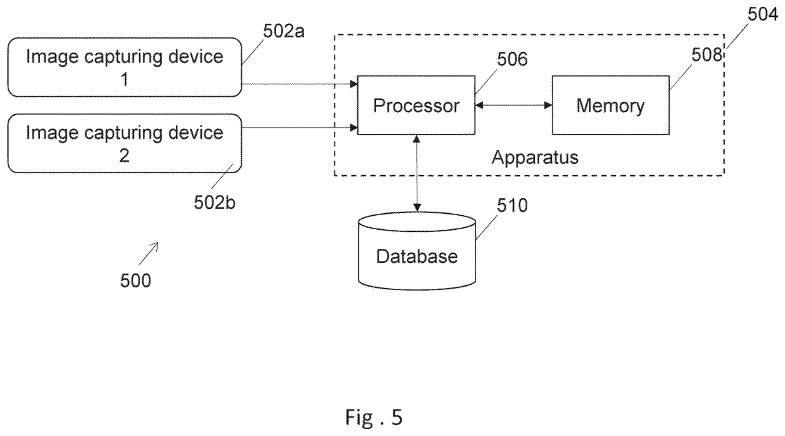

FIG. 5 shows a block diagram illustrating a system 500 for recognizing an action of an object from a first plurality of video streams according to various embodiments of the present disclosure.

In an example, the managing of image input and signal input is performed by every image capturing device 502a, 502b. The system 500 comprises multiple image capturing devices 502a, 502c (for the sake of simplicity, only two image capturing devices are illustrated) in communication with the apparatus 504. In an implementation, the apparatus 504 may be generally described as a physical device comprising at least one processor 506 and at least one memory 508 including computer program code. The at least one memory 508 and the computer program code are configured to, with the at least one processor 506, cause the physical device to perform the operations described in FIG. 4. The processor 506 is configured to receive a first plurality of video streams from the image capturing devices 502a, 502b or retrieve the first plurality of video streams from a database 510. Alternatively or additionally, the first plurality of video streams captured by the image capturing devices 502a, 502b are stored in a database 510, and the processor 506 is configured to retrieve first plurality of video streams from the database 510.

The image capturing device 502a, 502b may be a device such as a closed-circuit television (CCTV) which provides a variety of data (camera data) of which physical, motional/behaviour and object feature data that can be used by the system to detect an object under an object ID as well as to recognize an action of the object. In an implementation, the data derived from the image capturing devices 502a, 502b may be stored in memory 508 of the apparatus 504 or a database 510 accessible by the apparatus 504.

Additionally, camera data such as location data relating to a location at which the camera is fixated or capturing, time data such as timestamp of the video/image may be received, stored and/or retrieved to derive location and timestamp of an action relating to an object for recognizing an action of the object.

According to the present disclosure, the apparatus 504 may be configured to communicate with the image capturing devices 502a, 502b, the database 510 and multiple processing units (not shown). In one implementation, the processing units can be part of the apparatus 504 and are communicated with the processor 508. Similarly, in one implementation, the database 510 can be part of the apparatus 504.

The apparatus 504 may receive, from the image capturing device 502, or retrieve from the database 510, a plurality of video streams as input. The memory 506 and the computer program code stored therein are configured to, with the processor 506 cause the apparatus 504 or the image capturing devices 502a, 502b directly to detect an object from each of the plurality of video streams. The detection may be based on an appearance feature, a body part, a bodily characteristic, a motion of the object or a combination thereof.

The memory 508 or the database 510 may store an accuracy of each of the processing units in recognizing a target action(s) of the object (or other similar objects), and the processor 506 may retrieve such accuracy from the memory 508 or the database 510 and to assign each of the plurality of video streams to a processing unit to process and detect a target action of the object. The detection of a target action may be based on a sequence of physical features (e.g., appearance feature, body part, bodily characteristics) and/or motional/behaviour features (e.g., motions, movements) of the object identified from a video stream, for example, by running an action recognition model by the processing unit on the assigned video stream.

More particularly, the memory 508 and the computer program code stored therein are configured to, with the processor 506 cause the apparatus 504 to compare the respective accuracies of the processing units in recognizing a specific action(s) of the object (or other similar objects), and determine which processing unit has a higher (or highest) accuracy in detecting the action than other processing unit(s). The determination results will then be utilized by the processor 506 for the assignment of the video stream(s) to the processing unit(s) to detect and recognize an action of the object. In one implementation, a ranking table indicating a rank of each of the processing units in communication with the apparatus 504 is generated after the accuracy comparison, and the ranks of the processing units will be used directly to determine the assignment of the video streams, for example, a sequence of the processing units (e.g., from high accuracy processing unit to low accuracy processing unit) to be assigned to a video stream load.

In one embodiment, the memory 508 and the computer program code stored therein are configured to, with the processor 506 cause the apparatus 504 or the image capturing devices 502a, 502b to identify one or more features from each of the plurality of video streams. The memory 508 and the computer program code stored therein are configured to, with the processor 506 cause the apparatus 504 to then calculate a probability of a target action of an object (or similar objects) being recognized from the plurality of video streams.

Additionally, the memory 508 or the database 510 may store a weight parameter for each feature identified from the video stream, and the memory 508 and the computer program code stored therein are configured to, with the processor 506 cause the apparatus 504 to retrieve such weight parameter from the memory 508 or the database 510 and apply respective weight parameters to the one or more features identified from the video stream to calculate the probability of the target action of the object.

The memory 508 and the computer program code stored therein are configured to, with the processor 506 cause the apparatus 504 to further compare respective probabilities of a target action of an object (or similar objects) being recognized from the plurality of video streams, and determine which video stream has a higher (or highest) probability to have the target action being recognized by a processing unit than other video streams. The determination results will then be utilized by the processor 506 for the assignment of the video stream(s) to a processing unit(s). For example, a sequence of the video streams (e.g., from high probability to low probability) to be assigned to a processing unit may be determined from the results.

Additionally, the memory 508 and the computer program code stored therein are configured to, with the processor 506 cause a processing unit or device in communication with the apparatus 504 to run a deep learning model. The apparatus 504 may assign a video stream with known action to a processing unit to run an action recognition model to recognize the known action and receive an indication on whether the known action is accurately recognized from the video stream by the processing unit running the action recognition model. Alternatively, the apparatus 504 may receive an action recognition result from the processing unit indicating the action recognized from the video stream by the processing unit running the action recognition model, and the memory 508 and the computer program code stored therein are configured to, with the processor 506 cause the apparatus 504 to determine if the action of the object matches the known action and that the known action is accurately recognized by the processing unit running the action recognition model. If it is indicated that the action of the object is not recognized from the video stream, the memory 508 and the computer program code stored therein are configured to, with the processor 506 cause the apparatus 504 to update the weight parameters of the features detected by the processing unit from the video stream and contributed to the result of the action recognition such that the known action can be more accurately recognized from the video stream by the processing unit.

In alternative embodiment, the memory 508 and the computer program code stored therein are configured to, with the processor 506 cause the apparatus 504 to compare respective levels of importance of the plurality of video streams, and determine which video stream has a higher (or highest) level of importance to have the target action being recognized from it than other video streams. The determination results will then be utilized by the processor 506 for the assignment of a video stream to a processing unit. For example, a sequence of the video streams (e.g., from high probability to low probability) to be assigned to a processing unit may be determined from the results.

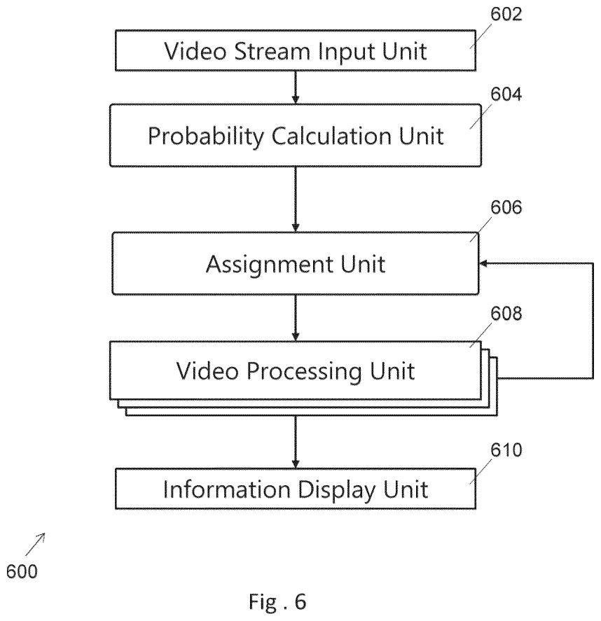

FIG. 6 shows a block diagram 600 illustrating various components of an action recognition apparatus of FIG. 5 and a process flow between them according to an embodiment of the present disclosure. In this embodiment, the action recognition apparatus 600 (or a processor of the action recognition apparatus 600) comprises a video stream input unit 602, a probability calculation unit 604, an assignment unit 606, video processing units 608 and an information display unit 610. As shown in the exemplified action recognition system in FIG. 1, the video stream input unit 602, video processing units 608 and the information display unit 610 may not be part of the action recognition apparatus 600 (or the processor of the action recognition apparatus 600).

As shown in the exemplified method for recognizing an action of an object in FIG. 4, the action recognition apparatus 600, when in operation, is configured to perform the following steps:
step 402, the video stream input unit 602 may detect an object from each of the first plurality of video streams; and
step 404, the assignment unit may assign one of the first plurality of video streams to one of the video processing units 608 to recognize an action of the object based on an accuracy in recognizing the action of the object of the one of the video processing units 608.

In step 402, the video stream input unit 602 may receive or retrieve the first plurality of video streams for example from multiple image capturing apparatuses or a database (not shown) prior to the detection of the object from the each of the first plurality of video streams. The video stream input unit 602 may be used to temporarily buffer the captured video streams and get the basic camera information (e.g., resolution, frame rate, etc.) for further processing.

Additionally, in step 402, the video stream input unit 602 may identify one or more features from the each of the first plurality of video streams for further processing by the probability calculation unit 604. Alternatively, such identification step may be carried by the probability calculation unit 604 itself.

Additionally, in step 402, the video stream input unit 602 may determine if a level of importance of each of the first plurality of video streams from which the action of the object is to be recognized. Alternatively, such determination step may be carried by the assignment unit 606 itself. Alternatively, the level of important of each of the first plurality of video streams are received from the image capturing apparatuses.

In step 404, prior to the assignment of the one of the first plurality of video streams to the one of the video processing units 608, the assignment unit 606 may retrieve an average recognition accuracy in recognizing the action of the object of the video processing units 608 from each of the video processing units 608 or a database (not shown) and determine if the average recognition accuracy of a processing unit is higher than each of the remaining video processing units. The assignment in step 404 will then be based on such determination result. The assignment unit 606 may further determine a rank of each video processing unit against the remaining video processing units. The assignment in step 404 will then be based on the rank of the one of the video processing units 608, for example, the assign video processing unit has the highest (or lowest) accuracy in recognizing the action of the object among all video processing units 608.

Also in step 404, prior to the assignment of the one of the first plurality of video streams to the one of the video processing units 608, the probability calculation unit 604 may calculate a probability of the action of the object being recognized from the each of the first plurality of video streams based on the one or more feature identified by itself or the video stream input unit 602 and determine if the probability of the action of the object being recognized from the one of the video streams is higher than that of each of the other video streams of the first plurality of video streams. The assignment unit 606 receives the video stream with the calculated probability from the probability calculation unit 604. The assignment in step 404 will then be based on such determination result, for example, the assigned video stream has the highest (or lowest) probability of detecting and recognizing the action of the object.

In one implementation, the assignment unit 606 maintains a video stream assignment table based on the rank of each video processing unit, update the video stream assignment based on new ranks of the video processing units calculated from their updated accuracies and assign video stream based on the video stream assignment table, for example, a video stream which has a higher probability of target action is assigned to a video processing unit which has a higher average action recognition accuracy.

Yet also in step 404, prior to the assignment of the one of the first plurality of video streams to the one of the video processing units 608, the assignment unit 608 may determine if a level of important of the one of the first plurality of video stream is higher than that of each of the other video streams of the first plurality of video streams. The assignment in step 404 will then be based on such determination result, for example, the assigned video stream from which the action of the object is to be recognized has the highest (or lowest) level of importance.

Subsequently, with the assignment, for those video processing units 608 which receive video stream, the video processing units 608 may then run an action recognition model to detect and recognize the target action of the object from the video stream assigned to it. If the target action detected and recognized, the video processing units 608 may then send an alert to the information display unit 610.

The information display unit 610 receives the alert with the target action recognition result output from the video processing units 608 and display the result (e.g., the probability) to the user.

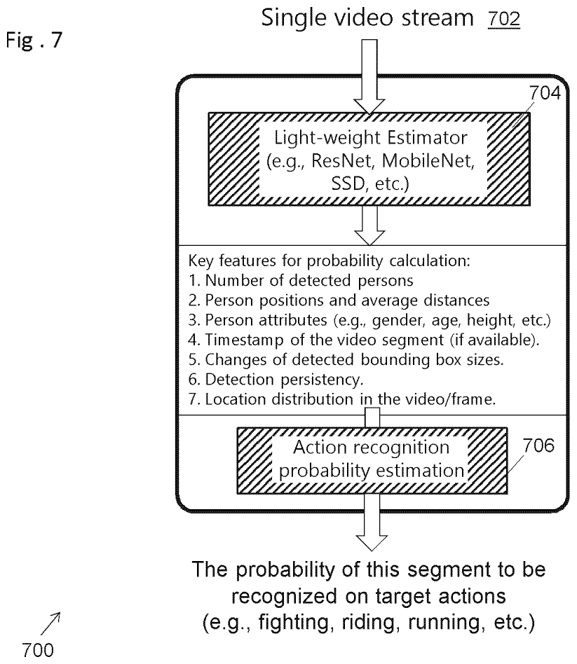

FIG. 7 shows a block diagram 700 illustrating a light-weight estimator 704 and an action recognition probability estimation unit 706 of a probability calculation unit according to an embodiment of the present disclosure. Each video stream 702 received from a video stream input unit is assigned to a light-weight estimator 704 of the probability calculation unit to identify one or more features. Examples of features include, but not limited to, number of detected person, person positions, average distances, person attribute (e.g., gender, age, height, etc.), timestamp of the video, changes of detected bounding box sizes, detection persistency (the duration, frequency, starting timestamp and ending timestamp of detection of the feature) and location distribution of various objects in the video/frame. Such identified features will then be used by the action recognition probability estimation unit 706 to estimate and calculate the probability of the action (e.g., fighting, riding, running, etc.,) being recognized from the video stream before sending to an assignment unit to assign the video stream 702 to a video processing unit to process and recognize the action of an object.

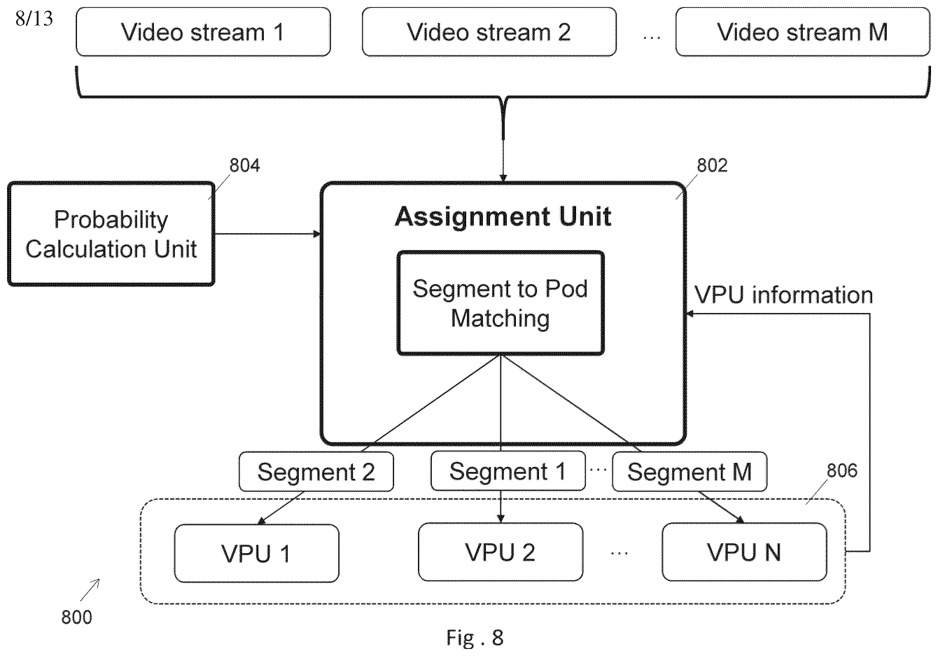

FIG. 8 shows a block diagram 800 illustrating an assignment unit 802 and its communication with a probability calculation unit 804 and multiple video processing units 806 (VPU 1, VPU 2, . . . , VPU N) according to an embodiment of the present disclosure. The assignment unit may receive multiple video streams (Video stream 1, Video stream 2, . . . , Video stream M). In this case, the number of video streams is M. The assignment unit 802 may receive VPU information such as action recognition accuracy from the video processing units 806. In this case, the number of VPUs is N, and N is smaller than M. Additionally, the assignment unit 802 may also receive the probability of detecting and recognizing a target action from each of the video streams from the probability calculation unit 804. The assignment unit 802 may assign each video stream to a VPU to process and recognize the target action based on the received probabilities and VPU information. In this embodiment, the assignment unit further comprises a Segment to Pod Matching subunit 803 to break up each of the video streams into video segments (Segment 1, Segment 2, and Segment M) and assign each video segments to a VPU. In this case, the number of video segments is M and the number of VPUs N is smaller than M. Based on the received probabilities of recognizing the target action from the video segments and VPU information, the assignment unit 802 assigns segment 2 to VPU 1, segment 1 to VPU 2 and segment M to VPU N.

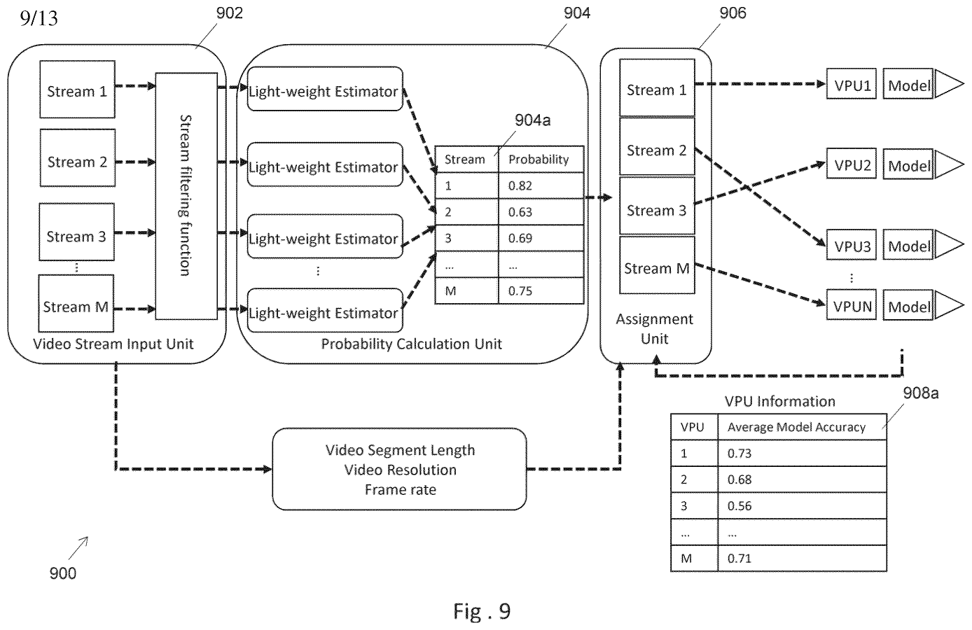

FIG. 9 shows a flowchart 900 illustrating a process overview of a video stream input unit, a probability calculation unit and an assignment unit of an action recognition apparatus according to an embodiment of the present disclosure.

The video stream input unit 902 receives a first plurality of video streams (stream 1, stream 2, stream 3, . . . , stream M) and carries out a stream filter function to filter irrelevant video stream (different locations) before transmitting the first plurality of video streams to the probability calculation unit 904. The video stream input unit 902 may also transmits basic camera information such as video segment length, video resolution, frame rate, and a level of importance of the video stream (not shown) to the assignment unit.

In the probability calculation unit 904, for each video stream, a light-weight estimator is assigned to process the video stream to calculate the probability of recognizing a target action from the video stream. In this case, as shown in table 904a, it is calculated that video streams 1, 2, 3, . . . , M have respective probabilities of 0.82, 0.63, 0.69, . . . , 0.75 of recognizing the target action.

The video streams and their respective probabilities are transmitted to the assignment unit 906 to assign each of the video streams to a video processing unit (VPU1, VPU2, VPU3, . . . , VPUN). The assignment maybe based on the probabilities, the basic camera information and VPU information received from the probability calculation unit 904, the video stream input unit 902 and the assignment unit 906 respectively.

The VPU information comprising an average accuracy of action recognition model run by each VPU is received from the processing units. In this case, as shown in table 908a, it is calculated that VPU1, VPU2, VPU3, . . . , VPUN have respective accuracies of 0.73, 0.68, 0.56, . . . , 0.71. Such accuracy may be ranked to form an assignment table indicating which VPU should be given the highest/lowest priority to assign to a video stream.

In one example, the assignment unit 906 may use scheduling algorithms to perform a stream-to-VPU matching to achieve an optimal or better recognition accuracy. For instance, the streams with high probability are assigned to the VPU with better model accuracy because these streams are considered with higher importance. Alternatively, the streams with high probability may be assigned to VPU with lower accuracy because the target action is easier to be recognized from the streams already and the requirement of VPU to recognize the target action is not as stringent.

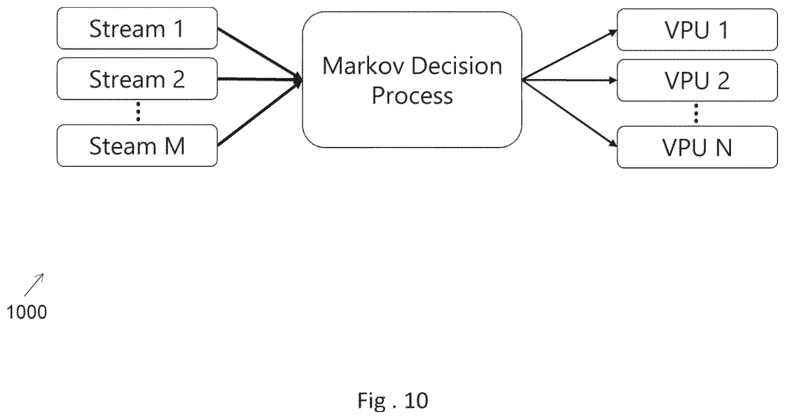

FIG. 10 shows a flowchart 1000 illustrating a Markov Decision Process used to assign each of first plurality of video streams to one of a second plurality of VPUs according to an embodiment of the present disclosure. The Markov Decision Process may be carried out to assign the video streams to the VPUs based on the following equation (1):

$$Average recognition accuracy = {\sum }_{i ∈ N} {Accuracy}_{i} ( S , A , P , R ) / N \qquad equation 1$$

where
State (S) relating to VPU queuing time, video resolution, segment length, probabilities;

$$Action ( A ) , where Tuple < Stream i , VPU j > for 1 \leq I = M , I \leq j \leq N ;$$

Probability (P) such as per-stream probability from probability calculation unit, and VPU average accuracy;
Reward (R) such as an average recognition accuracy for all the video streams.

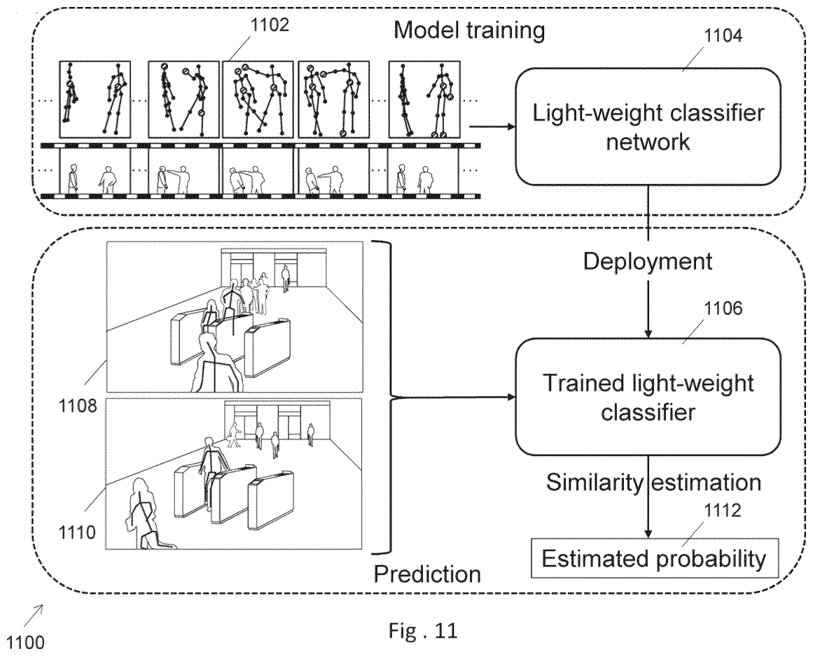

FIG. 11 shows a flowchart 1100 illustrating training process of the light-weight classifier or estimator according to an embodiment of the present disclosure. First, a training video stream 1102 with known actions (including physical, motional/behaviour, object features, combinations thereof leading to the recognition of the known actions) is fed to a light-weight classifier network for detecting and recognizing an action(s) from the training video stream for deep learning model training. The light-weight classifier network may have a pre-configured or an existing weight parameter for each physical, motional/behaviour or object feature or each combination thereof. An action(s) may be detected and recognized by a processing unit (not shown) based on some physical, motional/behaviour and object features identified from the training video stream. The detected and recognized action(s) may then be compared and matched against the known action(s) to check if the detection and recognition are accurate. If an indication is received, for example from the processing unit, indicating that the detected and recognized action(s) do not match the known action(s), the respective existing weight parameters of the identified the physical, motional/behaviour, object features and combinations (and/or other physical, motional/behaviour, object features and combinations contributing to the recognition of the known actions) are updated such that the known actions can be accurately detected and recognized.

Once the light-weight classifier network 1104 is able to identify physical, motional/behaviour, object features, combinations thereof and recognize known actions of all training video streams, it is then deployed as trained light-weight classifier 1106 in a probability calculation unit to estimate a probability of an actual video stream 1108, 1110 receives from video stream input unit. In one example, the estimation may be a similarity estimation where the similarity between the physical, motional/behaviour, object features identified from the actual video stream 1108, 1110 and those from each training video streams are calculated, and used to determine the probability 1112 of the (known) actions being recognized from the actual video stream. The estimated probability will be transmitted to the assignment unit (not shown) to assign the actual video stream to a processing unit to recognize the actions.

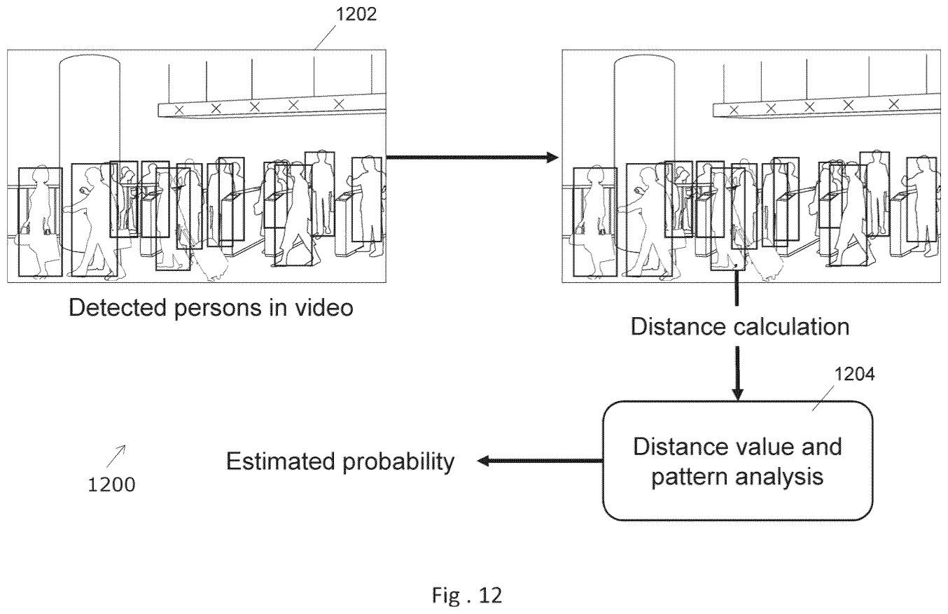

FIG. 12 shows a flowchart 1200 illustrating a process of calculating and estimating a probability of a target action from a video stream according to an embodiment of the present disclosure. In this embodiment, 11 different persons are detected from the video, as illustrated in rectangular boxes in the video frame 1202. A distance between each person and another person (e.g., the closest person) is calculated based on the distance between the respective boxes of the person and the other person. By analysing the distance value and pattern in step 1204, a probability of a target action (e.g., queuing, fighting) can be estimated.

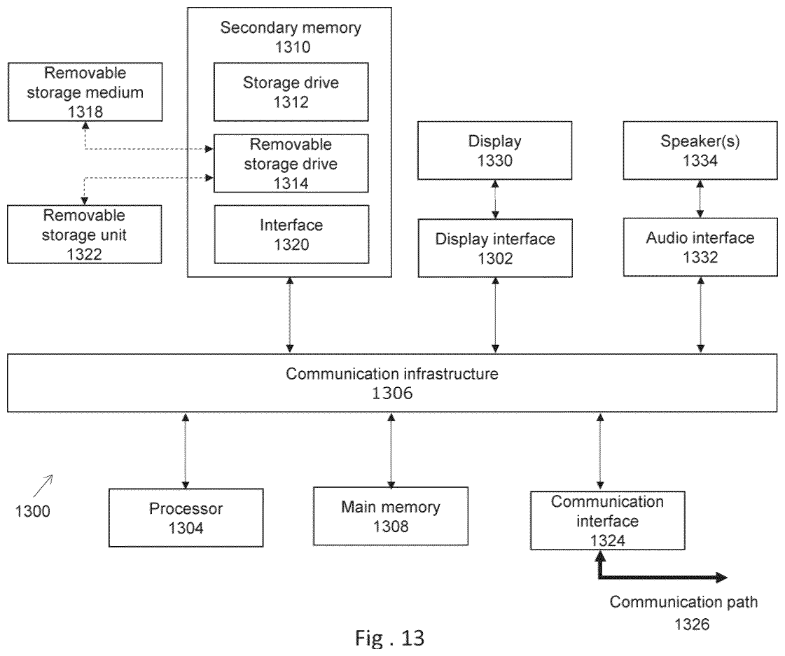

FIG. 13 shows a schematic diagram of an exemplary computing device 1300, hereinafter interchangeably referred to as a computer system 1300, where one or more such computing device 1300 may be used or suitable for use to execute the method in FIG. 4 and implement the apparatus in FIG. 5. The following description of the computing device 1300 is provided by way of example only and is not intended to be limiting.

As shown in FIG. 13, the example computing device 1300 includes a processor 1304 for executing software routines. Although a single processor is shown for the sake of clarity, the computing device 1300 may also include a multi-processor system. The processor 1304 is connected to a communication infrastructure 1306 for communication with other components of the computing device 1300. The communication infrastructure 1306 may include, for example, a communications bus, cross-bar, or network.

The computing device 1300 further includes a main memory 1308, such as a random access memory (RAM), and a secondary memory 1310. The secondary memory 1310 may include, for example, a storage drive 1312, which may be a hard disk drive, a solid state drive or a hybrid drive and/or a removable storage drive 1314, which may include a magnetic tape drive, an optical disk drive, a solid state storage drive (such as a USB flash drive, a flash memory device, a solid state drive or a memory card), or the like. The removable storage drive 1314 reads from and/or writes to a removable storage medium 1318 in a well-known manner. The removable storage medium 1318 may include magnetic tape, optical disk, non-volatile memory storage medium, or the like, which is read by and written to by removable storage drive 1314. As will be appreciated by persons skilled in the relevant art(s), the removable storage medium 1318 includes a computer readable storage medium having stored therein computer executable program code instructions and/or data.

In an alternative implementation, the secondary memory 1310 may additionally or alternatively include other similar means for allowing computer programs or other instructions to be loaded into the computing device 1300. Such means can include, for example, a removable storage unit 1322 and an interface 1320. Examples of a removable storage unit 1322 and interface 1320 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1322 and interfaces 1320 which allow software and data to be transferred from the removable storage unit 1322 to the computer system 1300.

The computing device 1300 also includes at least one communication interface 1324. The communication interface 1324 allows software and data to be transferred between computing device 1300 and external devices via a communication path 1326. In various embodiments of the disclosures, the communication interface 1324 permits data to be transferred between the computing device 1300 and a data communication network, such as a public data or private data communication network. The communication interface 1324 may be used to exchange data between different computing devices 1300 which such computing devices 1300 form part an interconnected computer network. Examples of a communication interface 1324 can include a modem, a network interface (such as an Ethernet card), a communication port (such as a serial, parallel, printer, GPIB, IEEE 1394, RJ45, USB), an antenna with associated circuitry and the like. The communication interface 1324 may be wired or may be wireless. Software and data transferred via the communication interface 1324 are in the form of signals which can be electronic, electromagnetic, optical or other signals capable of being received by communication interface 1324. These signals are provided to the communication interface via the communication path 1326.

As shown in FIG. 13, the computing device 1300 further includes a display interface 1302 which performs operations for rendering images to an associated display 1330 and an audio interface 1332 for performing operations for playing audio content via associated speaker(s) 1334.

As used herein, the term “computer program product” may refer, in part, to removable storage medium 1318, removable storage unit 1322, a hard disk installed in storage drive 1312, or a carrier wave carrying software over communication path 1326 (wireless link or cable) to communication interface 1324. Computer readable storage media refers to any non-transitory, non-volatile tangible storage medium that provides recorded instructions and/or data to the computing device 1300 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1300. Examples of transitory or non-tangible computer readable transmission media that may also participate in the provision of software, application programs, instructions and/or data to the computing device 1300 include radio or infra-red transmission channels as well as a network connection to another computer or networked device, and the Internet or Intranets including e-mail transmissions and information recorded on Websites and the like.

The computer programs (also called computer program code) are stored in main memory 1308 and/or secondary memory 1310. Computer programs can also be received via the communication interface 1324. Such computer programs, when executed, enable the computing device 1300 to perform one or more features of embodiments discussed herein. In various embodiments, the computer programs, when executed, enable the processor 1304 to perform features of the above-described embodiments. Accordingly, such computer programs represent controllers of the computer system 1300.

Software may be stored in a computer program product and loaded into the computing device 1300 using the removable storage drive 1314, the storage drive 1312, or the interface 1320. The computer program product may be a non-transitory computer readable medium. Alternatively, the computer program product may be downloaded to the computer system 1300 over the communications path 1326. The software, when executed by the processor 1304, causes the computing device 1300 to perform the necessary operations to execute the method in FIG. 5 and implement the apparatus in FIG. 6.

It is to be understood that the embodiment of FIG. 13 is presented merely by way of example to explain the operation and structure of the apparatus. Therefore, in some embodiments one or more features of the computing device 1300 may be omitted. Also, in some embodiments, one or more features of the computing device 1300 may be combined together. Additionally, in some embodiments, one or more features of the computing device 1300 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

This application is based upon and claims the benefit of priority from Singapore patent application No. 10202260150 W, filed on Nov. 21, 2022, the disclosure of which is incorporated herein in its entirety by reference.

### SUPPLEMENTARY NOTES

The whole or part of the example Aspects disclosed above can be described as, but not limited to, the following supplementary notes.

### Supplementary Note 1

A method for recognizing an action of an object from a first plurality of video streams, the method comprising:
detecting the object from each of the first plurality of video streams; and
assigning one of the first plurality of video streams to one of a second plurality of processing units to recognize the action of the object based on an accuracy in recognizing the action of the object of the one of the second plurality of processing units.

### Supplementary Note 2

The method of supplementary note 1, further comprising:
determining if the accuracy in recognizing the action of the object of the one of the second plurality of processing units is higher than that of each of the remaining of the second plurality of processing units, wherein the assignment of the one of the first plurality of video streams to the one of the second plurality of processing units to recognize the action of the object is based on a result of the determination of the accuracy.

### Supplementary Note 3

The method of supplementary note 2, further comprising:
determining a rank of the one of the second plurality of processing units against the remaining of the second plurality of processing units based on the respective accuracies in recognizing the action of the object, wherein the assignment of the one of the first plurality of video streams to the one of the second plurality of processing units to detect the action of the object is based on the rank of the one of the second plurality of processing units.

### Supplementary Note 4

The method of any one of supplementary notes 1 to 3, further comprising:
determining if a probability of the action of the object being recognized from the one of the first plurality of video streams is higher than that of each of other video streams of the first plurality of video streams, wherein the assignment of the one of the first plurality of video streams to the one of the second plurality of processing units to recognize the action of the object is based on a result of the determination the probability.

### Supplementary Note 5

The method of supplementary note 4, further comprising:
identifying one or more features from each of the first plurality of video streams; and
calculating a probability of the action of the object being recognized from the each of the first plurality of video streams based on the one or more features identified from the each of the first plurality of video streams, wherein the determination of the probability of the action being recognized from the one of the first plurality of video streams is based on the respective calculated probabilities of the one of the first plurality of video streams and the each of the video streams of the first plurality of video streams.

### Supplementary Note 6

The method of supplementary note 5, further comprising:
applying a weight parameter to each of the one or more features to calculate the probability of the action of the object being recognized from the each of the first plurality of video streams.

### Supplementary Note 7

The method of supplementary note 6, further comprising:
receiving an indication on whether the action of the object is recognized from the each of the first plurality of video streams, and
   updating the weight parameter of the each of the one or more features based on the indication.

### Supplementary Note 8

The method of any one of supplementary notes 5 to 7, wherein the one or more features identified from the each of the first plurality of video streams comprises at least one of: a number of objects detected from the each of the first plurality of video streams, a location of the object, a position of a part of the object, a relative distance between the object and another object, a physical attribute relating to the object, a movement of the object, a timestamp at which the object and/or an action of the object is detected, a change in a box size of the object in the each of the first plurality of video streams, a duration during which the object and/or an action of the object is detected, and a location distribution of different objects in the each of the first plurality of video streams.

### Supplementary Note 9

The method of any one of supplementary notes 1 to 8, further comprising:
determining if a level of importance of the one of the first plurality of video streams is higher than that of each of other video streams of the first plurality of video streams, wherein the assignment of the one of the first plurality of video streams to the one of the second plurality of video streams to recognize the action of the object is further based on a result of the determination of the level of importance.

### Supplementary Note 10

The method of any one of supplementary notes 1 to 9, further comprising:
determining at least one of (i) a processing time of the one of the second plurality of processing units, (ii) a resolution of the one of the first plurality of video streams, and (iii) a duration of the one of the first plurality of video streams, wherein the assignment of the one of the first plurality of video streams to the one of the second plurality of video streams to recognize the action of the object is based on a result of the determination of the at least one of the processing time, the resolution and the duration of the one of the first plurality of video streams.

### Supplementary Note 11

The method of any one of supplementary notes 1 to 10, wherein a number of the first plurality of video streams is greater than a number of the second plurality of processing units.

### Supplementary Note 12

The method of any one of supplementary notes 1 to 11, further comprising:
receiving the first plurality of video streams from a third plurality of image capturing apparatuses.

### Supplementary Note 13

An apparatus for recognizing an action of an object from a first plurality of video streams, the apparatus comprising:
at least one processor; and
at least one memory including computer program code;
the at least one memory and the computer program code configured to, with at least one processor, cause the apparatus at least to:
   recognize the object from each of the first plurality of video streams; and
   assign one of the first plurality of video streams to one of a second plurality of processing units to recognize the action of the object based on an accuracy in recognizing the action of the object of the one of the second plurality of processing units.

### Supplementary Note 14

The apparatus of supplementary note 13, wherein the at least one memory and the computer program code configured to, with at least one processor, cause the apparatus at least to further:
determine if the accuracy in recognizing the action of the object of the one of the second plurality of processing units is higher than that of each of the remaining of the second plurality of processing units; and
assign the one of the first plurality of video streams to the one of the second plurality of processing units to recognize the action of the object based on a result of the determination of the accuracy.

### Supplementary Note 15

The apparatus of supplementary note 14, wherein the at least one memory and the computer program code configured to, with at least one processor, cause the apparatus at least to further:
determine a rank of the one of the second plurality of processing units against the remaining of the second plurality of second processing units based on the respective accuracies in recognizing the action of the object; and
assign the one of the first plurality of video streams to the one of the second plurality of processing units to recognize the action of the object based on the rank of the one of the second plurality of processing units.

### Supplementary Note 16

The apparatus of any one of supplementary notes 13 to 15, wherein the at least one memory and the computer program code configured to, with at least one processor, cause the apparatus at least to further:
determine if a probability of the action of the object being recognized from the one of the first plurality of video streams is higher than that of each of other video streams of the first plurality of video streams;
assign the one of the first plurality of video streams to the one of the second plurality of processing units to recognize the action of the object further based on a result of the determination the probability.

### Supplementary Note 17

The apparatus of supplementary note 16, wherein the at least one memory and the computer program code configured to, with at least one processor, cause the apparatus at least to further:
identify one or more features from each of the first plurality of video streams; and
calculate a probability of the action of the object being recognized from the each of the first plurality of video streams based on the one or more features identified from the each of the first plurality of video streams, and
determine the probability of the action being recognized from the one of the first plurality of video streams based on the respective calculated probabilities of the one of the first plurality of video streams and the each of the video streams of the first plurality of video streams.

### Supplementary Note 18

The apparatus of supplementary note 17, wherein the at least one memory and the computer program code configured to, with at least one processor, cause the apparatus at least to further:
apply a weightage to each of the one or more features to calculate the probability of the action of the object being recognized from the each of the first plurality of video streams.

### Supplementary Note 19

The apparatus of supplementary note 18, wherein the at least one memory and the computer program code configured to, with at least one processor, cause the apparatus at least to further:
receive an indication on whether the action of the object is recognized from the each of the first plurality of video streams, and
update the weightage of the each of the one or more features based on the indication.

### Supplementary Note 20

The apparatus of any one of supplementary notes 17 to 19, wherein the one or more features identified from the each of the first plurality of video streams comprises at least one of: a number of objects detected from the each of the first plurality of video streams, a location of the object, a position of a part of the object, a relative distance between the object and another object, a physical attribute relating to the object, a movement of the object, a timestamp at which the object and/or an action of the object is detected, a change in a box size of the object in the each of the first plurality of video streams, a duration during which the object and/or an action of the object is detected, and a location distribution of different objects in the each of the first plurality of video streams.

### Supplementary Note 21

The apparatus of any one of supplementary notes 13 to 20, wherein the at least one memory and the computer program code configured to, with at least one processor, cause the apparatus at least to further:
determine if a level of importance of the one of the first plurality of video streams is higher than that of each of other video streams of the first plurality of video streams; and
assign the one of the first plurality of video streams to the one of the second plurality of processing units to detect the action of the object further based on a result of the determination of the level of importance.

### Supplementary Note 22

The apparatus of any one of supplementary notes 13 to 21, wherein the at least one memory and the computer program code configured to, with at least one processor, cause the apparatus at least to further:
determine at least one of (i) a processing time of the one of the second plurality of processing units, (ii) a resolution of the one of the first plurality of video streams, and (iii) and a duration of the one of the first plurality of video streams; and
assign the one of the first plurality of video streams to the one of the second plurality of processing units to recognize the action of the object based on a result of the determination of the at least one of the processing time, the resolution and the duration of the one of the first plurality of video streams.

### Supplementary Note 23

The apparatus of any one of supplementary notes 13 to 22, wherein a number of the first plurality of video streams is greater than a number of the second plurality of processing units.

### Supplementary Note 24

The apparatus of any one of supplementary notes 13 to 23, wherein the at least one memory and the computer program code configured to, with at least one processor, cause the apparatus at least to further:
receive the first plurality of video streams from a third plurality of image capturing apparatuses.

### Supplementary Note 25

A system for recognizing an action of an object from a first plurality of video streams, comprising the apparatus of any one of supplementary notes 13 to 24 and a third plurality of image capturing apparatuses.

### REFERENCE SIGNS LIST

302 Requestor Device
308 Action Recognition Server
340 Coordination Server
342 Sensor
350 Host
502 Image Capturing Device
504 Apparatus
506 Processor
508 Memory
510 Database
602 Video Stream Input Unit
604 Probability Calculation Unit
606 Assignment Unit
608 Video Processing Unit
610 Information Display Unit
802 Assignment Unit
804 Probability Calculation Unit
806 Multiple Video Processing Units
1302 Display Interface
1304 Processor
1306 Communication Infrastructure
1308 Main Memory
1310 Secondary Memory
1312 Storage Drive
1314 Removable Storage Drive
1318 Removable Storage Medium
1320 Interface
1322 Removable Storage Unit
1324 Communication Interface
1330 Display
1332 Audio Interface
1334 Speaker(s)

What is claimed is:

1. A method for recognizing an action of an object from a first plurality of video streams, the method comprising:
detecting the object from each of the first plurality of video streams; and
assigning one of the first plurality of video streams to one of a second plurality of processing units to recognize the action of the object based on an accuracy in recognizing the action of the object of the one of the second plurality of processing units.

2. The method of claim 1, further comprising:
determining if the accuracy in recognizing the action of the object of the one of the second plurality of processing units is higher than that of each of the remaining of the second plurality of processing units, wherein the assignment of the one of the first plurality of video streams to the one of the second plurality of processing units to recognize the action of the object is based on a result of the determination of the accuracy.

3. The method of claim 2, further comprising:
determining a rank of the one of the second plurality of processing units against the remaining of the second plurality of processing units based on the respective accuracies in recognizing the action of the object, wherein the assignment of the one of the first plurality of video streams to the one of the second plurality of processing units to detect the action of the object is based on the rank of the one of the second plurality of processing units.

4. The method of claim 1, further comprising:
determining if a probability of the action of the object being recognized from the one of the first plurality of video streams is higher than that of each of other video streams of the first plurality of video streams, wherein the assignment of the one of the first plurality of video streams to the one of the second plurality of processing units to recognize the action of the object is based on a result of the determination the probability.

5. The method of claim 4, further comprising:
identifying one or more features from each of the first plurality of video streams; and
calculating a probability of the action of the object being recognized from the each of the first plurality of video streams based on the one or more features identified from the each of the first plurality of video streams, wherein the determination of the probability of the action being recognized from the one of the first plurality of video streams is based on the respective calculated probabilities of the one of the first plurality of video streams and the each of the video streams of the first plurality of video streams.

6. The method of claim 5, further comprising:
applying a weight parameter to each of the one or more features to calculate the probability of the action of the object being recognized from the each of the first plurality of video streams.

7. The method of claim 6, further comprising:
receiving an indication on whether the action of the object is recognized from the each of the first plurality of video streams, and
updating the weight parameter of the each of the one or more features based on the indication.

8. The method of claim 5, wherein the one or more features identified from the each of the first plurality of video streams comprises at least one of: a number of objects detected from the each of the first plurality of video streams, a location of the object, a position of a part of the object, a relative distance between the object and another object, a physical attribute relating to the object, a movement of the object, a timestamp at which the object and/or an action of the object is detected, a change in a box size of the object in the each of the first plurality of video streams, a duration during which the object and/or an action of the object is detected, and a location distribution of different objects in the each of the first plurality of video streams.

9. The method of claim 1, further comprising:
determining if a level of importance of the one of the first plurality of video streams is higher than that of each of other video streams of the first plurality of video streams, wherein the assignment of the one of the first plurality of video streams to the one of the second plurality of video streams to recognize the action of the object is further based on a result of the determination of the level of importance.

10. The method of claim 1, further comprising:
determining at least one of (i) a processing time of the one of the second plurality of processing units, (ii) a resolution of the one of the first plurality of video streams, and (iii) a duration of the one of the first plurality of video streams, wherein the assignment of the one of the first plurality of video streams to the one of the second plurality of video streams to recognize the action of the object is based on a result of the determination of the at least one of the processing time, the resolution and the duration of the one of the first plurality of video streams.

11. The method of claim 1, wherein a number of the first plurality of video streams is greater than a number of the second plurality of processing units.

12. The method of claim 1, further comprising:
receiving the first plurality of video streams from a third plurality of image capturing apparatuses.

13. An apparatus for recognizing an action of an object from a first plurality of video streams, the apparatus comprising:
at least one processor; and
at least one memory including computer program code;
the at least one memory and the computer program code configured to, with at least one processor, cause the apparatus at least to:
recognize the object from each of the first plurality of video streams; and
assign one of the first plurality of video streams to one of a second plurality of processing units to recognize the action of the object based on an accuracy in recognizing the action of the object of the one of the second plurality of processing units.

14. The apparatus of claim 13, wherein the at least one memory and the computer program code configured to, with at least one processor, cause the apparatus at least to further:
determine if the accuracy in recognizing the action of the object of the one of the second plurality of processing units is higher than that of each of the remaining of the second plurality of processing units; and
assign the one of the first plurality of video streams to the one of the second plurality of processing units to recognize the action of the object based on a result of the determination of the accuracy.

15. The apparatus of claim 14, wherein the at least one memory and the computer program code configured to, with at least one processor, cause the apparatus at least to further:
determine a rank of the one of the second plurality of processing units against the remaining of the second plurality of processing units based on the respective accuracies in recognizing the action of the object; and
assign the one of the first plurality of video streams to the one of the second plurality of processing units to recognize the action of the object based on the rank of the one of the second plurality of processing units.

16. The apparatus of claim 13, wherein the at least one memory and the computer program code configured to, with at least one processor, cause the apparatus at least to further:
determine if a probability of the action of the object being recognized from the one of the first plurality of video streams is higher than that of each of other video streams of the first plurality of video streams;
assign the one of the first plurality of video streams to the one of the second plurality of processing units to recognize the action of the object further based on a result of the determination the probability.

17. The apparatus of claim 16, wherein the at least one memory and the computer program code configured to, with at least one processor, cause the apparatus at least to further:
identify one or more features from each of the first plurality of video streams; and
calculate a probability of the action of the object being recognized from the each of the first plurality of video streams based on the one or more features identified from the each of the first plurality of video streams, and
determine the probability of the action being recognized from the one of the first plurality of video streams based on the respective calculated probabilities of the one of the first plurality of video streams and the each of the video streams of the first plurality of video streams.

18. The apparatus of claim 17, wherein the at least one memory and the computer program code configured to, with at least one processor, cause the apparatus at least to further:
apply a weightage to each of the one or more features to calculate the probability of the action of the object being recognized from the each of the first plurality of video streams.

19. The apparatus of claim 18, wherein the at least one memory and the computer program code configured to, with at least one processor, cause the apparatus at least to further:
receive an indication on whether the action of the object is recognized from the each of the first plurality of video streams, and
update the weightage of the each of the one or more features based on the indication.

20. The apparatus of claim 17, wherein the one or more features identified from the each of the first plurality of video streams comprises at least one of: a number of objects detected from the each of the first plurality of video streams, a location of the object, a position of a part of the object, a relative distance between the object and another object, a physical attribute relating to the object, a movement of the object, a timestamp at which the object and/or an action of the object is detected, a change in a box size of the object in the each of the first plurality of video streams, a duration during which the object and/or an action of the object is detected, and a location distribution of different objects in the each of the first plurality of video streams.

21-25. (canceled)
